(19) United States
(12) Patent Application Publication
(10) Pub. No.: US 2008/0129502 A1
(43) Pub. Date: Jun. 5, 2008

(54) Security system and security method

(75) Inventors: Mario Fuse, Kanagawa (JP); Shoji Yamaguchi, Kanagawa (JP); Yasunori Koda, Kanagawa (JP); Kunihiro Takahashi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/819,687

(22) Filed: Jun. 28, 2007

(30) Foreign Application Priority Data
Nov. 30, 2006 (JP) P2006-323069

(51) Int. Cl. G08B 13/14

(52) U.S. Cl. 340/568.1

(57) ABSTRACT

A security system includes: an ordinary document output apparatus that outputs an ordinary document which is a non-secret document; a secret document output apparatus that outputs a secret document to a medium having a detection target unit and being a dedicated medium for the secret document; and detection units that are provided at each of at least a first passage, or an entrance and exit of the first passage, and a second passage, or a entrance and exit of the second passage, and that detects the detection target unit, the first passage being used when the secret document is moved from the secret document corresponding region to the ordinary document corresponding region, and the second passage being used when the secret document is moved from at least one of the ordinary document corresponding region and the secret document corresponding region to an outside of the space.

### CROSS-REFERENCE TO RELATED APPLICATIONS

This application is based on and claims priority under 35 U.S.C. 119 from Japanese Patent Application No. 2006-323069 filed Nov. 30, 2006.

### BACKGROUND

1. Technical Field

The present invention relates to a security system and a security method.

2. Related Art

Hitherto, a method of preliminarily adding an element, such as a magnetic tag or a radio frequency identification (RFID), to a secret document, which requires the preservation of confidentiality, and sounding an alarm or blocking up an exit door when detecting the presence of the element in the document at a detection gate provided at an exit of an office space, has been proposed as a technique of restricting such a secret document from being taken out from the office space. Also, a method of embedding a magnetic material, which causes a large Barkhausen effect (or discontinuity), in a sheet of paper, on which a secret document is output, as an element used to discriminate the secret document.

### SUMMARY

According to an aspect of the present invention, a security system comprising: an ordinary document output apparatus that is installed in an ordinary document corresponding region, and that outputs an ordinary document which is a non-secret document; a secret document output apparatus that is installed outside the ordinary document corresponding region and in a secret document corresponding region, and that outputs a secret document to a medium having a detection target unit and being a dedicated medium for the secret document, the ordinary document corresponding region and the secret document corresponding region constituting a space so that the secret document corresponding region includes the ordinary document corresponding region; and detection units that are provided at each of at least a first passage, or an entrance and exit of the first passage, and a second passage, or a entrance and exit of the second passage, and that detects the detection target unit, the first passage being used in a case where the secret document is moved from the secret document corresponding region to the ordinary document corresponding region, and the second passage being used in a case where the secret document is moved from at least one of the ordinary document corresponding region and the secret document corresponding region to an outside of the space.

Incidentally, an operation of “outputting an ordinary document” includes mainly a printout. Additionally, the operation of “outputting an ordinary document” includes, for example, the storage of computerized electronic data in a document storage medium, and the transmission of electronic data to an opponent party through a communication line. Also, an operation of “outputting a secret document” includes the output of the document to a media, for example, the printout of a document to a paper medium, or the writeout of a document to a storage medium, and does not include the transmission of electronic data to an opponent party. The “medium exclusively used for a secret document” has a detection target unit to maintain confidentiality. The “detection target unit” enables the detection unit to detect that the document is a secret document.

### BRIEF DESCRIPTION OF THE DRAWINGS

Exemplary embodiment of the present invention will be described in detail based on the following figures, wherein:

FIG. 1 is an explanatory view illustrating an outline of a first embodiment of a security system according to the invention;

FIG. 2 is a first explanatory view illustrating an outline of a second embodiment of the security system according to the invention;

FIG. 3 is a second explanatory view illustrating the outline of the second embodiment of the security system according to the invention;

FIG. 4 is a third explanatory view illustrating the outline of the second embodiment of the security system according to the invention;

FIG. 5 is an explanatory view illustrating the outline of the second embodiment of the security system according to the invention; and

FIGS. 6A and 6B are explanatory views illustrating an example of the configuration of a gate in the security system according to the invention.

### DETAILED DESCRIPTION

Hereinafter, a security system according to the invention is described with reference to the accompanying drawings.

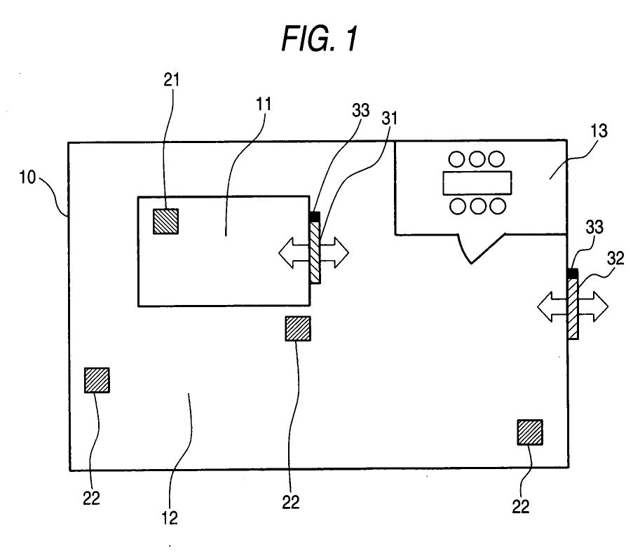

First, a first embodiment of the invention is described. FIG. 1 is an explanatory view illustrating an outline of a first embodiment of a security system according to the invention.

The security system to be exemplified below is applied to an office space 10. The office space 10 is defined to be an enclosed space (or a closed space), which is separated from an exterior by walls to handle secret documents. Incidentally, the security system may also be applied to a space (e.g., a commercial space) other than the office space, as long as it is separated from the exterior by walls and requires the preservation of confidentiality. The space other than the office space is, for example, an examination room required preventing the leakage of examination questions, and a conference hall required preventing information on results of studies and new products from being released using paper media before disclosed, and also preventing documents from being taken out therefrom.

The security system constructed in the office space 10 is configured so that an ordinary document corresponding region 11 and a secret document corresponding region 12 are provided in the office space 10, and that the ordinary document corresponding region 11 is placed in the secret document corresponding region 11. That is, these regions 11 and 12 are provided so that the secret document corresponding region 11 includes the ordinary document corresponding region 11. It is assumed that the secret document corresponding region 12 and the ordinary document corresponding region 11 are separated from each other by walls, except for a passage or an entrance/exit, through which persons move.

The ordinary document corresponding region 11 is a spatial domain in which the document-outputs of ordinary documents defined to be non-secret documents unnecessary to maintain confidentiality are performed.

Also, an ordinary document output apparatus 21 is installed in the ordinary document corresponding region 11 so as to perform the document output of ordinary documents. The ordinary document output apparatus 21 outputs ordinary documents which are non-secret documents. For example, in the case of printing out an ordinary document as an output, a copier and a printer, which print out the ordinary document on sheets of paper for ordinary documents (e.g., general plain paper or recycled paper), correspond to the ordinary document output apparatus 21.

Meanwhile, the secret document corresponding region 12 is a spatial domain to which the document outputs of secret documents requiring the preservation of confidentiality are performed. As will be described later, the preservation of confidentiality is improved by detecting a medium.

Also, a secret document output apparatus 22 is installed in the secret document corresponding region 12 other than the ordinary document corresponding region 11 so as to perform the document outputs of secret documents. The secret document output apparatus 22 outputs secret documents. Incidentally, the secret document output apparatus 22 is adapted to output a secret document to a medium (not shown) exclusively used for secret documents.

A practical example of the medium exclusively used for a secret document is a paper medium in which a magnetic material is embedded as the detection target unit (see, for example, JP-A-2004-285624 and JP-A-2006-59258). Additionally, it has been devised that elements, such as a magnetic tag and an RFID, are used as the detection target unit, and that a paper medium, to which such an element is added, is used as the medium exclusively used for a secret document. Furthermore, it has been devised that, instead of a paper medium, a disk-like storage medium, such as a magnetic disk or an optical disk, serves as the medium exclusively used for a secret document, by adding a member or an element serving as the detection target unit thereto.

Meanwhile, to maintain confidentiality, all secret documents should be output to the medium exclusively used for a secret document. Thus, a document output restriction unit (not shown) configured to restrict a document from being output to a medium other than the medium exclusively used for a secret document is provided in the secret document output apparatus 22. For example, in a case where a document is printed out to a paper medium, it is sufficient to provide a unit, which is adapted to inhibit the secret document output apparatus 22 from being filled with media other than the medium exclusively used for a secret document, as the document output restriction unit. More specifically, a mechanism configured to inhibit a person having no legitimate right from filling a sheet feeding unit with a paper medium is provided. Alternatively, a mechanism configured to detect the detection target unit in the medium exclusively used for a secret document on a sheet transport path to inhibit the printout of the document to a medium other than the medium exclusively used for a secret document is provided.

Incidentally, the number of the ordinary document output apparatuses 12 installed in the ordinary document corresponding region 11 and the number of the secret document output apparatuses 22 installed in the secret document corresponding region 12 are not limited to specific values. It is useful to determine the number of the ordinary document output apparatuses 12 installed therein and the number of the secret document output apparatuses 22 installed therein according to the size of the spatial domains. Additionally, another apparatus configured to perform a process other than the document output can be provided in each of the regions 11 and 12 in addition to the associated one of the ordinary document output apparatus 21 and the secret document output apparatus 22. However, regarding the document output, only the ordinary document output apparatus 21 is provided in the ordinary document corresponding region 11. Also, only the secret document output apparatus 22 is provided in the secret document corresponding region 12.

The ordinary document corresponding region 11 and the secret document corresponding region 12 communicate with each other through the gate 31 through which persons move. The secret document corresponding region 12 and the exterior communicate with each other through the gate 32 through which persons move. Each of the gates 31 and 32 can be either a passage having a certain movement distance or an entrance/exit constituted by a gateway or a door. The number of the gates provided in the system is not limited to a specific value. It is advisable to determine the number of the gates 31 and 32 according to the size of the ordinary document corresponding region 11 or the secret document corresponding region 12.

Incidentally, the gates 31 and 32 are provided with detection unit 33 which are disposed at least at a passage or an entrance/exit used for movement from the secret document corresponding region 12 to the ordinary document corresponding region 11 and a passage or an entrance/exit used for movement from the secret document corresponding region 12 to the exterior, respectively. For example, in a case where a paper medium, in which a magnetic material is embedded, is used as the medium exclusively used for a secret document, a detector having an exciting coil and a detection coil can be used as the detection unit 33 which detects the magnetic material by utilizing a large Barkhausen effect (or discontinuity) (see, e.g., JP-A-2004-285524 and JP-A-2006-59258). Additionally, in a case where the detection target unit is the element, such as the magnetic tag or RFID, it is sufficient to use a detector that is appropriate therefor. Incidentally, the magnetic tag is adapted to detect the magnetic material therein utilizing the magnetic effect (e.g., a large Barkhausen effect and a magneto-acoustic effect) in the magnetic material. That is, it is sufficient that the detection unit 33 configured to detect the detection target unit can detect the detection target unit in a noncontact detection manner. Additionally, it is sufficient that the detection unit 33 is provided “at least” at a part, which is used at the movement from the secret document corresponding region to the ordinary document corresponding region, and at a part, which is used at the movement from the secret document corresponding region to the exterior. Additionally, the detection unit 33 can be provided at a part, which is used at the movement from the ordinary document corresponding region to the secret document corresponding region, and at a part, which is used at the movement from the exterior of the secret document corresponding region 12 into the secret document corresponding region 12.

Next, an operation of the security system of the above configuration is described below.

In the security system of the above configuration, the secret document output apparatus 22 is installed in a part of the secret document corresponding region 12 except the ordinary document corresponding region 11. In a case where the secret document corresponding region 12 is set to be large, the degree, at which a person carrying a secret document can freely move in the secret document corresponding region 12, is high, as compared with a case where the secret document corresponding region 12 is set to be small. Accordingly, a person working in the secret document corresponding region 12 can choose any document output apparatus placed in the region for outputting a secret document, and when the region contains a conference room 13, a person carrying a secret document can go into and out of the conference room 13 without restriction.

The document output of a secret document is performed by the secret document output apparatus 22 in the secret document corresponding region 12. The secret document output apparatus 22 has a document output restriction unit configured to restrict a document from being output to a medium other than the medium exclusively used for a secret document. Thus, secret documents are output to the medium exclusively used for a secret document, which has the detection target unit.

The secret document corresponding region 12, in which the output of the secret document is performed, is an enclosed space separated from the exterior. A person passes through the gate 32, when he or she goes between the secret document corresponding region 12 and the exterior thereof. Incidentally, the detection unit 33 is provided at the passage or the entrance/exit of the gate 32 to detect the detection target unit passing through the gate 32, when a person having a security document moves from the secret document corresponding region 12 to the exterior thereof. Therefore, when the detection unit 33 detects the detection target unit, the blockade door is closed to block up the gate 32. Alternatively, an alarm is issued. Thus, the medium which has the detection target unit and is exclusively used for a secret document, that is, a secret document, the document output of which has been performed, can be restricted from being carried out of the secret document corresponding region 12.

On the other hand, the ordinary document output apparatus 21 is installed in the ordinary document corresponding region 11 included in the secret document corresponding region 12. The ordinary document corresponding region 11 is a space separated from the secret document corresponding region 12 by walls. Persons move between the ordinary document corresponding region 11 and the exterior thereof through the gate 31. The detection unit 33 configured to detect the detection target unit is provided at the passage or the entrance/exit used for the movement into the ordinary document corresponding region 11 from the exterior of the region 11. Therefore, the detection unit 33 is provided at the passage or the entrance/exit of the gate 31, which is used for the movement from the exterior of the region 11 into the region 11. Accordingly, when the detection unit 33 detects the detection target unit, for example, the blockade door is closed. Alternatively, an alarm is issued. Consequently, the medium having the detection target unit, which is exclusively used for a secret document, that is, the secret document, the document output of which has been performed, can be restricted from being carried into the ordinary document corresponding region 11. It has been devised that when the detection unit 33 detects the detection target unit, all the ordinary document output apparatuses 21 provided in the ordinary document corresponding region 11 are stopped or disabled. More specifically, a power supply for a multi-functional printer or the like is turned off. That is, even when the ordinary document output apparatus 21 is installed in the ordinary document corresponding region 11, the copying of information described in a secret document, which has been output to the medium exclusively used for a secret document, onto sheets of plain paper through the use of the ordinary document output apparatus 21 can be banned by restricting this medium from being carried into the ordinary document corresponding region 11.

The security system of the above configuration presupposes that the carry-in of the medium exclusively used for a secret document into the ordinary document corresponding region 11 proves the intention to preliminarily output a secret document to a medium other than the medium exclusively used for a secret document. Thus, the security system of the above configuration restricts the carry-in of the medium exclusively used for a secret document into the ordinary document corresponding region 11 by detecting the detection target unit included in this medium, in addition to the carry-out of the medium exclusively used for a secret document to the exterior of the secret document corresponding region 12.

Additionally, the ordinary document corresponding region 11 is included in the secret document corresponding region 12. This means that when the medium is taken out to the exterior of the office space 10 from the ordinary document corresponding region 11, the medium inevitably passes through the secret document corresponding region 11. Therefore, in a case where the detection unit 33 at the gate 31 is provided at the part used for the movement from the ordinary document corresponding region 11 to the secret document corresponding region 12 in addition to the part used for the movement from the secret document corresponding region 12 to the ordinary document corresponding region 11, the medium should undergo double checkups until reaching the exterior of the office space 10.

However, ordinary documents defined to be non-secret documents are not objects of the detection at the gates 31 and 32. Thus, the carrying of ordinary documents is not restricted in the ordinary document corresponding region 11, the secret document corresponding region 12, and the exterior of the office space 10. That is, in a case where a secret document and an ordinary document are handled in a state in which the secret document and the ordinary document coexist in the office space 10, the leakage of information described in the secret document is restricted, without restricting the carrying of the ordinary document.

That is, the security system of the above configuration centrally controls the ordinary document output apparatus 21, which can be a security hole, by enclosing the ordinary document output apparatus 21 in the ordinary document corresponding region 11 in view of security protection. Also, to prevent reduction in operating efficiency in the office space 10, this security system restricts the carrying of a medium exclusively used for a secret document, to which the secret document is output.

As already described above, it has been devised that a paper medium including a magnetic material having a large Barkhausen effect(or discontinuity) is used as an example of the medium exclusively used for a secret document, which is to be carried.

This paper medium is formed integrally with the magnetic material. Thus, it is difficult to separate the magnetic material from the paper medium, as compared with the medium to which the element, such as the RFID, is added. For the medium, to which the element, such as an RFID with an antenna, is added, detection performance may degrade as a result of the breakage of the antenna or the element when being bended. However, the paper medium, in the entire surface of which the magnetic material is embedded, can hold bending-resistance.

Also, the paper medium including the magnetic material preliminarily contains the magnetic material, differently from the case where the element, such as the RFID, is added to a paper medium by being retrofit thereto. Thus, as long as the paper medium including the magnetic material is reliably loaded into the secret document output apparatus 22, the management of the apparatus is not cumbersome. A failure of attaching the element does not occur. Additionally, the paper medium including the magnetic material excels in surface smoothness, as compared with the case of adding the element to the medium. Thus, the paper medium including the magnetic material can easily be applied to electrophotographic printing and thermal-transfer printing. Also, because the element is not retrofit to the paper medium including the magnetic material, document destruction can be performed directly using a shredder, without removal, dissolution, and burnout of the element.

Also, a method of causing the paper medium to include the magnetic material is, for example, to embed the magnetic material into the paper medium in a paper making process, and to apply embrocation including the magnetic material to a paper medium. The paper medium, into which the magnetic material is embedded, can eliminate the influence of the partial loss of the paper medium at the detection by the detection unit 33, depending upon the manner of embedding the magnetic material therein, for example, by embedding the magnetic material in the entire surface of the paper medium (see, e.g., JP-A-2004-285524). Additionally, the paper medium, into which the magnetic material is embedded, can eliminate the influence of detection directivity at the detection, which is performed by the detection unit 33, by excluding a specific direction orientation to embed the magnetic material therein (see, e.g., JP-A-2004-285524). Furthermore, the paper medium, into which the magnetic material is embedded, can enhance detection precision at the detection, which is performed by the detection unit 33, by embedding the magnetic material into the paper medium to have a specific direction orientation (see, e.g., JP-A-2006-59258).

A medium exclusively used for a secret document is preliminarily loaded in the secret document output apparatus 22 configured to perform the output of the document to the medium exclusively used for a secret document. Also, the document output restriction unit restricts the secret document output apparatus from performing the output of a document to a medium other than the medium exclusively used for a secret. Thus, the document output of a secret document using the secret document output apparatus 22, that is, the document output of a secret document is performed on a medium exclusively used for a secret document.

Incidentally, the secret document output apparatus 22 may be configured so that information specifying an output applicant, a requested output apparatus, and the secret document output apparatus 22 having output a secret document is written to the medium exclusively used for a secret document. When outputting a secret document by writing such information to the medium exclusively used for a secret document, history of output of documents to this medium can be known, for example, even in a case where this medium is abandoned. Thus, an abandoner can be identified. The technique of writing information to the medium exclusively used for a secret medium can be implemented utilizing known techniques. Thus, the description of the technique of writing the information is omitted herein.

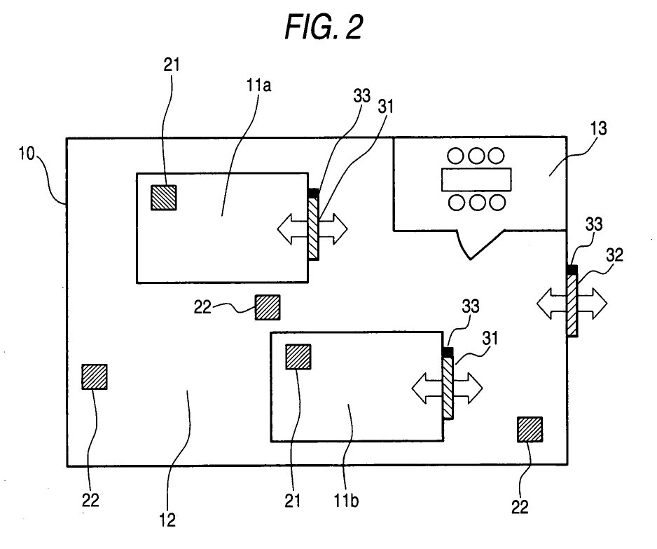

Next, a second embodiment of the invention is described below. Described is the second embodiment of a configuration, in which the arrangement of an ordinary document corresponding region 11 and a secret document corresponding region 12 in an office space 10 differs from that in the first embodiment. The differences between the first embodiment and the second embodiment are also described. FIGS. 2 to 4 are explanatory views illustrating an outline of the second embodiment of the security system according to the invention.

The security system of the configuration shown in FIG. 2 is provided with a plurality of ordinary document corresponding regions 11a and 11b in a secret document corresponding region 12. This corresponds to a case where the office space 10 is formed in a house, for example, a multifloor building, and where an ordinary document corresponding region 11 is provided on each floor thereof. That is, this configuration corresponds to a case where a target space to be protected from secret leakage is not only a single room and is expanded to the house (i.e., the building) including this room. In the security system of such a configuration, a person carrying a secret document can move among the floors. Thus, reduction in working efficiency in this house can be subdued, while leakage of information described in a secret document to the exterior of the house is prevented. Additionally, the range of extension of the space is not limited to the inside of the building, and can be within a predetermined site (e.g., an office establishment site). In a case where a plurality of ordinary document corresponding regions 11a and 11b are provided in the secret document corresponding region 12, reduction in the number of gates 31 and 32 having detection unit can be expected, as compared with a case where a plurality of secret document corresponding regions 12 are provided in the ordinary document corresponding region, and where secret document output apparatuses 22 are put together in the secret document corresponding regions.

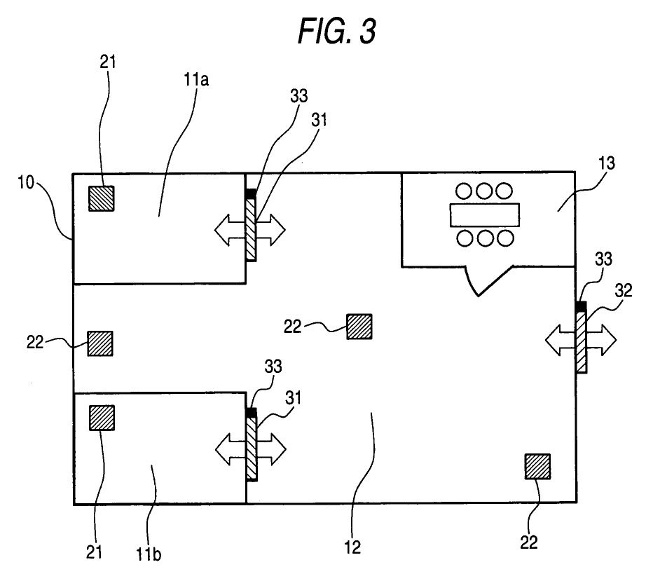

The security system of the configuration shown in FIG. 3 is provided with a plurality of ordinary document corresponding regions 11a and 11b configured in a secret document corresponding region 12 so that the plurality of ordinary document corresponding regions 11a and 11b are brought in contact with wall surfaces of the secret document corresponding region 12. That is, a part of wall surfaces partitioning the ordinary document corresponding regions 11a and 11b also serves as a part of the wall surfaces partitioning the secret document corresponding region 12. Even in the case of the security system of this configuration, as long as gates 31 and 32 are not provided in parts of the wall surfaces, which are common to the regions 11a, 11b, and 12, and other entrances/exits and windows are not disposed in such parts of the wall surfaces, information described in a secret document can be restricted from being leaked to the exterior. Also, when a part of the wall surfaces of the regions 11a, 11b, and 12 are used in common to these regions, effective utilization of the space can be achieved in a case where the secret document corresponding region 12 and the ordinary document corresponding regions 11a and 11b are disposed in the office space 10.

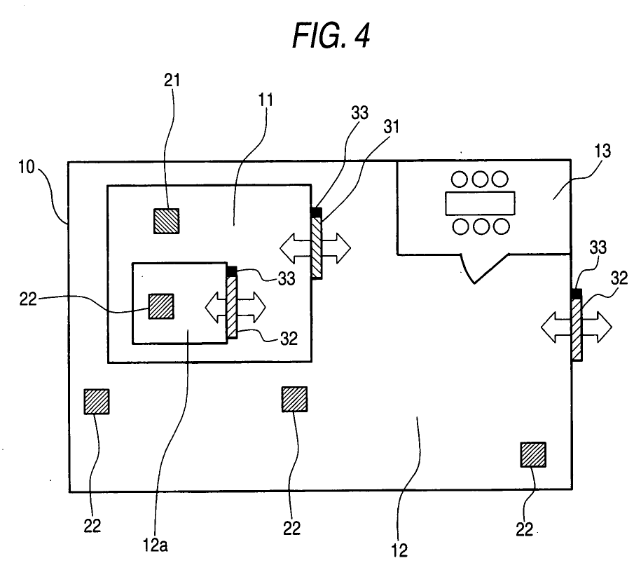

The security system shown in FIG. 4 is such that a secret document corresponding region 12a is provided in an ordinary document corresponding region 11 enclosed in a secret document corresponding region 12. For example, the ratio of the number of secret documents to the number of all documents is defined as a ratio R (=(the number of secret documents)/(the number of all documents)). Among departments present in the office space 10, some departments (e.g., an accounting department and an intellectual property department) have high ratios R, while some departments (e.g., an investigation department) have low ratios R. These departments are disposed in the same office space 10. This security system is an example of applying the invention to the case of this configuration. More specifically, in a case where a department having a low ratio R is disposed at the ordinary document corresponding region 11, among documents created in this department, there is a document which initially does not require the preservation of confidentiality and comes to include, after edited, secret information by increasing confidentiality. Such information is obtained by, for instance, initially collecting general information and then checking the information by comparison with company management strategy information according to a result of investigation, and finally editing investigated information from a certain view point. Thus, a secret document corresponding region 12a dedicated to handle secret documents is provided in the ordinary document corresponding region 11. With this configuration, in a case where the carry-out from the secret document corresponding region 12a of the medium exclusively used for a secret document is detected at the gate 32, all the ordinary document output apparatuses 21 in the ordinary document corresponding region 11 are put into a stopped state, or a disabled state. Additionally, the gate 32 at the secret document corresponding region 12 is closed. Consequently, an illegal doer can be trapped.

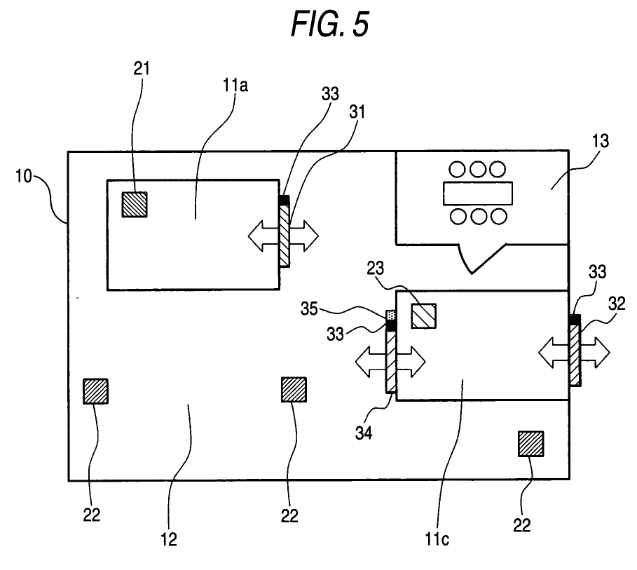

Next, a third embodiment of the invention is described below. Described in the following is the second embodiment of a configuration, in which the arrangement of a secret document corresponding region 12 and an ordinary document corresponding region 11 in an office space 10 differs from those in the first and second embodiments. Also, the differences between the third embodiment and each of the first embodiment and the second embodiment are described. FIG. 5 is an explanatory view illustrating an outline of the third embodiment of the security system according to the invention.

In the security system of a configuration shown in FIG. 5, one of the ordinary document corresponding regions 11c is put into contact with the gate 34 corresponding to the secret document corresponding region 12 and is disposed so that a person can move between the exterior of the office space 10 and the inside of the ordinary document corresponding region 11c through the gate 32. Thus, the ordinary document corresponding region 11c is included in the secret document region 12. Accordingly, the ordinary document corresponding region 11c faces the gate 32, through which a person moves between the inside of the ordinary document corresponding region 11c and the exterior of the office space 10 (i.e., the exterior of the secret document corresponding region 12), and a gate 34 through which a person moves between the inside of the ordinary document corresponding region 11c and the inside of the office space 10.

In the security system of such a configuration, a depository 23 of an image acquisition apparatus having an imaging function is disposed in the ordinary document corresponding region 11c which faces each of the gates 32 and 34. The “image acquisition apparatus” is obtained by adapting an apparatus having the imaging function utilizing a CCD (Charge-Coupled Device) sensor or a CMOS(Complementary Metal-Oxide Semiconductor) sensor so that a person can portably carry the “image acquisition apparatus”. More specifically, the “image acquisition apparatus” include, for example, a digital camera, a camera-equipped mobile phone, and a handy type scanner apparatus.

Also, at least an apparatus carry-in restriction unit 35 configured to restrict a medium from being brought into the secret document corresponding region 12 of the image acquisition apparatus, is provided at a passage or an entrance/exit, which is used for movement from the secret document corresponding region 12 to the inside of the region 12, at the gate 34 through which a person moves between the inside of the ordinary document corresponding region 11c and the exterior of the secret document corresponding region. For example, an apparatus configured to is devised as the apparatus carry-in restriction unit 35. Incidentally, an apparatus, which detects an element, such as a magnetic tag or RFID, preliminarily added to the image acquisition apparatus using a corresponding detector and which, for example, blocks the gate 34 by closing the blockade door or issues an alarm when detecting that the element passes through the gate, to thereby restrict the image acquisition apparatus from being carried into the secret document corresponding region 12, can be employed as the apparatus carry-in restriction unit 35. Incidentally, an apparatus configured to detect the image acquisition apparatus using other known techniques can be employed as the apparatus carry-in restriction unit 35.

In the case of the security system of such a configuration, first, a person working in the office space 10 enters the ordinary document corresponding region 11c through the gate 32. The person deposits the image acquisition apparatus, which has been carried by the person in the ordinary document corresponding region 11c, to the depository 23. The depository 23 stores the image acquisition apparatus corresponding to each of the individuals or the departments. It is devised that a lock unit is provided in the depository 23 corresponding to each of the individuals and the departments. Incidentally, even when the image acquisition apparatus is not deposited to the depository 23 and when the person carrying the image acquisition apparatus passes through the gate 34 connected to the secret document corresponding region 12, the person holding the image acquisition apparatus is restrained from passing through the gate 34. That is, the apparatus carry-in restriction unit 35 restricts the image acquisition apparatus from being carried into the secret document corresponding region 12. In a case where the apparatus carry-in restriction unit 35 detects the image acquisition apparatus, it is devised that the document output apparatuses 21 and 22 provided in the secret document corresponding region 12 (including the ordinary document corresponding region 11a contained in the secret document corresponding region 12) are put into a stopped state, or a disabled state. Additionally, it is devised that the lock unit provided in the depository 23 of the ordinary document corresponding region 11c is put into a locked state to thereby inhibit the apparatus from being taken out of the depository 23.

Thus, in the security system having the apparatus carry-in restriction unit 35, the apparatus carry-in restriction unit 35 restricts the image acquisition apparatus from being carried into the secret document corresponding region 12. Consequently, information described in the secret document can be prevented from being output by the ordinary document output apparatus 21 as an ordinary document. Also, information described in the secret document can be prevented from being imaged by the image acquisition apparatus.

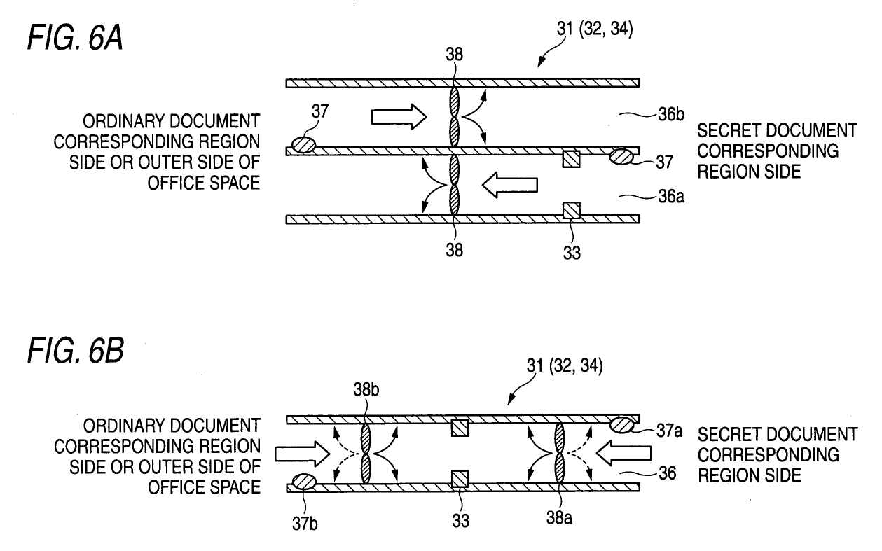

Next, a fourth embodiment of the invention is described below. In the following description, the configuration of each of the gates 31, 32, and 34 of the first to third embodiments is described in more detail by giving actual examples. FIGS. 6A and 6B are explanatory views illustrating the configurations of the gates.

Each of the gates 31, 32, and 34 shown in FIG. 6A enables a person to move between the secret document corresponding region 12, which is shown at a right side part of FIG. 6A, and the ordinary document corresponding region 11 or the exterior of the office space 10, which is shown at a left side part of FIG. 6A. Each of the gates 31, 32, and 34 has two one-way passages 36a and 36b, the directions of passengers' movement of which are opposite to each other. For example, an IC card reader 37 is disposed at an entrance of each of the passages 36a and 36b as an authentication unit configured to authenticate users of the passages 36a and 36b. A blockade door 38 adapted to be “opened” in response to a result of reading the IC card reader 37 is disposed at the downstream side in a direction of movement of the IC card reader 37. Consequently, in the passages 36a and 36b, only persons having legitimate rights are allowed to pass therethrough. Other persons are inhibited by closing the door 38 from passing therethrough.

The detection unit 33 configured to detect the detection target unit embedded in the medium exclusively used for a secret document is provided at the upstream side in the direction of passengers' movement (indicated by an arrow in the passage 36a) from the blockage door 38 “at least” in the passage 36a used for movement from the secret document corresponding region 12 to the ordinary document corresponding region 11 or the exterior of the office space 10. Because the detection unit 33 is provided “at least” in the passage 36a, the detection unit 33 can be provided in both the passages 36a and 36b. Additionally, when the detection unit 33 detects the detection target unit, the blockade door 38 is closed in response to detection made by the detection unit 33. The detection target unit, that is, the medium having the detection target unit, which is exclusively used for a secret document, is inhibited from passing therethrough.

Incidentally, FIG. 6A illustrates a case where each of the gates 31, 32, and 34 has the two one-way passages 36a and 36b. However, in a case where each of the gates is formed of an entrance/exit constituted by a gateway or a door, instead of the passage having a certain moving distance, it is useful to dispose the IC card reader 37 and the detection unit 33 at the upstream side in the direction of movement of the gateway or the door.

Each of the gates 31, 32, and 34 shown in FIG. 6B enables a person to move between the secret document corresponding region 12, which is shown at a right side part of FIG. 6B, and the ordinary document corresponding region 11 or the exterior of the office space 10, which is shown at a left side part of FIG. 6B. Each of the gates 31, 32, and 34 has a single two-way passage 36 through which a person can pass (or move) in both directions. An IC card reader 37a serving as the authentication unit is disposed at the side of the secret document corresponding region 12 in the passage 36. Also,in the passage, a blockade door 38a, which operates in response to a result of reading by the IC card reader 37a, is disposed at the downstream side in the direction of movement. Additionally, only persons having legitimate rights are permitted to pass from the secret document corresponding region 12 to the ordinary document corresponding region 11 or to the exterior of the office space 10. Other persons are inhibited by closing the blockade door 38a from passing therethrough. Also, the detection unit 33 configured to detect the detection target unit embedded in the medium exclusively used for a secret document is disposed at the downstream side from the blockade door 38a in the direction of the movement. Moreover, a blockade door 38b, which operates in response to a result of detection made by the detection target unit embedded in the medium exclusively used for a secret document, is disposed at the downstream side in the direction of the movement. When the detection unit 33 detects that the detection target unit passes therethrough, the blockade door 38b is closed to thereby inhibit the detection target unit from passing therethrough. Meanwhile, the single passage 36 deals with two-way movement. Thus, an IC card reader 37b serving as the authentication unit is also disposed at the side of the ordinary document corresponding region 11 or the exterior of the office space 10. When the detection target unit moves from the ordinary document corresponding region 11 or the exterior of the office space 10 to the secret document corresponding region 12, the blockade door 38b operates in response to a result of reading by the IC card reader 37b. Also, the blockade door 38a is configured to operate in response to a result of detection by the detection unit 33.

Incidentally, FIG. 6B illustrates a case where each of the gates 31, 32, and 34 has the single two-way passage 36. However, in a case where each of the gates is formed of an entrance/exit constituted by a door or a gateway, instead of the passage having a certain moving distance, it is useful to integrate the blockade doors 38a and 38b as a single door or gateway. Also, it is useful to dispose the IC card readers 37a and 37b and the detection unit 33 at the single gateway or at both sides (i.e., an entrance side and an exit side) of the door.

In either of the configurations shown in FIGS. 6A and 6B, according to the security system constructed using the gates 31, 32, and 34, a secret document is inhibited by closing the blockade doors 38, 38a, and 38b from being carried into the ordinary document corresponding region 11, and from being taken out of the office space 10.

Additionally, each of the gates 31, 32, and 34 is provided with the IC card reader 37, or the IC card readers 37a, and 37b in addition to the detection unit 33. Thus, according to a result of reading by the IC card readers 37, 37a, and 37b, that is, a result of authentication using the IC card of a user of each of the gates 31, 32, and 34, the user can be identified. Also, information identifying the user can be managed by being associated with a result of detection by the detection unit 33. Therefore, in addition to the inhibition of a person having no legitimate right from passing therethrough, the identification of the department, to which a person belongs, and the name of this person having tried to leak secret information, can be achieved.

Incidentally, the authentication based on a result of reading by the IC card reader 37, 37a, or 37b can be implemented utilizing known techniques. Thus, the description of such techniques is omitted herein. Also, the authentication is not necessarily based on a result of reading by the IC card reader 37, 37a, or 37b. That is, the authentication unit configured to authenticate a user is not limited to that utilizing the IC card readers 37, 37a, and 37b. The authentication utilizing the input of a password, and biometrics based on a finger print or on an iris, which utilizes other known techniques, can be employed.

The security systems according to the above first to fourth embodiments of the invention are preferred actual embodiments of the invention. The security systems according to the invention are not limited thereto. Various changes can be made without departing from the spirit and scope of the invention.

What is claimed is:

1. A security system comprising:
an ordinary document output apparatus that is installed in an ordinary document corresponding region, and that outputs an ordinary document which is a non-secret document;
a secret document output apparatus that is installed outside the ordinary document corresponding region and in a secret document corresponding region, and that outputs a secret document to a medium having a detection target unit and being a dedicated medium for the secret document, the ordinary document corresponding region and the secret document corresponding region constituting a space so that the secret document corresponding region includes the ordinary document corresponding region; and
detection units that are provided at each of at least a first passage, or an entrance and exit of the first passage, and a second passage, or a entrance and exit of the second passage, and that detects the detection target unit, the first passage being used in a case where the secret document is moved from the secret document corresponding region to the ordinary document corresponding region, and the second passage being used in a case where the secret document is moved from at least one of the ordinary document corresponding region and the secret document corresponding region to an outside of the space.

2. The security system as claimed in claim 1, wherein the secret document comprises a paper medium including a magnetic material, and the detection unit detects the magnetic material.

3. The security system as claimed in claim 1, wherein the secret document output apparatus comprises a document output restriction unit which restricts a document from being output to a media other than the dedicated medium for the secret document.

4. The security system as claimed in claim 1, wherein the secret document corresponding region comprises a plurality of the ordinary document corresponding regions.

5. The security system as claimed in claim 1, further comprising:
an apparatus carry-in restriction unit that is provided at a third passage, or an entrance and exit of the third passage, and that restricts an image acquisition apparatus having an imaging function from being carried into the secret document corresponding region, the third passage being used in a case where the image acquisition apparatus is moved from an outside of the secret document corresponding region to the secret document corresponding region.

6. The security system as claimed in claim 1, further comprising:
an authentication unit that is provided at at least one of the first passage, or the entrance and exit of the first passage, and the second passage, or the entrance and exit of the second passage, and that authenticates a user of the space.

7. A security method comprising:
providing
an ordinary document output apparatus that is installed in an ordinary document corresponding region, and that outputs an ordinary document which is a non-secret document; and
a secret document output apparatus that is installed outside the ordinary document corresponding region and in a secret document corresponding region, and that outputs a secret document to a medium having a detection target unit and being a dedicated medium for the secret document, the ordinary document corresponding region and the secret document corresponding region constituting a space so that the secret document corresponding region includes the ordinary document corresponding region; and
detecting the detection target unit at each of at least a first passage, or an entrance and exit of the first passage, and a second passage, or a entrance and exit of the second passage, the first passage being used in a case where the secret document is moved from the secret document corresponding region to the ordinary document corresponding region, and the second passage being used in a case where the secret document is moved from at least one of the ordinary document corresponding region and the secret document corresponding region to an outside of the space.
